(19) United States
(12) Patent Application Publication
(10) Pub. No.: US 2025/0309648 A1
(43) Pub. Date: Oct. 2, 2025

(54) POWER SUPPLY METHOD, APPARATUS, ELECTRONIC DEVICE, STORAGE MEDIUM AND COMPUTER PROGRAM PRODUCT

(71) Applicants: Jiangxing Wu, Zhengzhou (CN); CHUN-YI WANG, Taipei (CN); Dongqiang Wu, Chongqing (CN)

(72) Inventors: Jiangxing Wu, Zhengzhou (CN); CHUN-YI WANG, Taipei (CN); Dongqiang Wu, Chongqing (CN)

(21) Appl. No.: 19/069,417

(22) Filed: Mar. 4, 2025

(30) Foreign Application Priority Data
Mar. 27, 2024 (CN) 2024103600133

(51) Int. Cl. H02J 3/14; H02J 3/38

(52) U.S. Cl. CPC H02J 3/144; H02J 3/38; H02J 2300/24; H02J 2300/28

(57) ABSTRACT

The present application provides a power supply method and apparatus, an electronic device, a storage medium and a computer program product. The method includes: acquiring user's power demand information and power supply information of a first power source within a first preset period of time, the first power source being a power source that uses renewable energy to generate electricity. Based on the power demand information and the power supply information, it is determined whether power provided by the first power source meets user's demand within the first preset period of time. If the power provided meets the demand, power switching is performed, and the system switches to the first power source to supply power to the user.

### TECHNICAL FIELD

The present application relates to the field of electric power, and in particular to a power supply method and apparatus, an electronic device, a storage medium and a computer program product.

### BACKGROUND

Micro-Grid, also referred to as a microgrid, is a small power generation and distribution system composed of distributed power sources, energy storage devices, energy conversion devices, loads, monitoring and protection devices, etc. The development and extension of microgrids may fully promote the large-scale access of distributed power sources and renewable energy, achieve a highly reliable supply of multi-energy forms to loads, and it is an effective way to realize active distribution networks, and make a transition from a traditional grid to a smart grid.

Microgrids may supply power to users from various new energy power sources, such as wind, photovoltaic, hydraulic, or even traditional utility power. However, under the condition of multiple power sources, there is currently a lack of accurate supply and demand matching, and reasonable and effective power supply method for the microgrid.

### SUMMARY

The present application provides a power supply method and apparatus, an electronic device, a storage medium and a computer program product, to resolve the shortcomings of the current lack of accurate supply and demand matching, and reasonable and effective power supply method for a microgrid under the condition of multiple power sources.

The present application provides a power supply method. The method includes acquiring user's power demand information and the power supply information of a first power source within a first preset period of time. The first power source uses renewable energy to generate electricity. Based on the power demand information and the power supply information, it is determined whether power provided by the first power source meets user's demand within the first preset period of time. If the power provided meets the demand, power switching is performed, and the system switches to the first power source to supply power to the user.

According to the power supply method provided by the present application, the power demand information includes user demand power. The power supply information of the first power source includes output power of the first power source. The first power source includes at least one of a wind power source, a photovoltaic power source, a hydraulic power source, a biomass energy power source, a geothermal energy power source, or a first energy storage power source. Determining whether the power provided by the first power source meets the user's demand within the first preset period of time based on the power demand information and the power supply information of the first power source includes: comparing output power of each first power source with the user demand power to determine whether there is a first power source of which output power is greater than or equal to the user demand power, and determining that the power provided by the first power source meets the user's demand within the first preset period of time if there is the first power source of which the output power is greater than or equal to the user demand power. Performing the power switching, and switching to the first power source to supply power to the user if it is determined that the power provided by the first power source meets the user's demand within the first preset period of time includes: switching to the first power source of which the output power is greater than or equal to the user demand power for independently supplying power to the user.

According to the power supply method provided by the present application, after determining whether the power provided by the first power source meets the user's demand within the first preset period of time based on the power demand information and the power supply information of the first power source, the method further includes: performing power switching, and switching to a second power source to supply power to the user if it is determined that the power provided by any first power source fails to meet the user's demand within the first preset period of time, where the second power source is a utility power source; and performing energy storage on the first energy storage power source based on the first power source.

According to the power supply method provided by the present application, after determining whether the power provided by the first power source meets the user's demand within the first preset period of time based on the power demand information and the power supply information of the first power source, the method further includes: determining a difference between the user demand power and output power of each first power source respectively if it is determined that the power provided by any first power source fails to meet the user's demand within the first preset period of time; determining whether there is a first power source corresponding to a difference less than or equal to a preset threshold; switching to the first power source corresponding to the difference less than or equal to the preset threshold for independently supplying power to the user within the first preset period of time, if there is the first power source corresponding to the difference less than or equal to the preset threshold; within a second preset period of time, performing power switching and switching to a first power source of which output power is greater than the user demand power to supply power to the user, and complementing a power demand difference of the user within the first preset period of time, where the second preset period of time is a future period of time of the first preset period of time.

According to the power supply method provided by the present application, after determining whether there is the first power source corresponding to the difference less than or equal to the preset threshold, the method further includes: performing power switching and switching to a second power source to supply power to the user if there is no first power source corresponding to the difference less than or equal to the preset threshold, where the second power source is a utility power source.

According to the power supply method provided by the present application, the method further includes: performing power supply compensation based on a second energy storage power source when power switching is performed.

The present application further provides a power supply apparatus, including: an acquiring module, used for acquiring user's power demand information and power supply information of a first power source within a first preset period of time, where the first power source is a power source that uses renewable energy to generate electricity; a determining module, used for determining whether power provided by the first power source meets user's demand within the first preset period of time based on the power demand information and the power supply information of the first power source; and a switching module, used for performing power switching and switching to the first power source to supply power to the user if it is determined that the power provided by the first power source meets the user's demand within the first preset period of time.

The present application further provides an electronic device, including a memory, a processor and a computer program stored in the memory and executable by the processor, where the processor implements any one of the power supply methods described above when executing the program.

The present application further provides a non-transitory computer-readable storage medium storing a computer program, where the computer program, when executed by a processor, implements any one of the power supply methods described above.

The present application further provides a computer program product, including a computer program, where the computer program, when executed by a processor, implements any one of the power supply methods described above.

The power supply method, apparatus, the electronic device, the storage medium and the computer program product is provided by the present application. The method includes: acquiring user's power demand information and the power supply information of a first power source within a first preset period of time, where the first power source is the power source that uses renewable energy to generate electricity; determining whether the power provided by the first power source meets the user's demand within the first preset period of time based on the power demand information and the power supply information of the first power source; performing power switching and switching to the first power source to supply power to the user if it is determined that the power provided by the first power source meets the user's demand within the first preset period of time. Through the above method, the first power source is a power source that uses renewable energy to generate electricity and it is determined that whether the power provided by the first power source meets the user's demand within the first preset period of time based on the power demand information and the load information of the first power source within the first preset period of time. If it is determined that the power provided by the first power source meets the user's demand within the first preset period of time, the power switching is performed, and a current power source is switched to the first power source to supply power to the user. Therefore, under the condition of multiple power sources, the power source that uses renewable energy to generate electricity may be prioritized for the power supply of microgrid users, thereby reducing pollution to the environment on the premise of ensuring the power supply of users. The power supply method is scientific and reasonable.

### BRIEF DESCRIPTION OF THE DRAWINGS

To more clearly illustrate solutions in the present application or the prior art, the drawings used in the description of the embodiments are briefly described below. The drawings described below are some embodiments of the present application, and other drawings may be obtained according to these drawings without any creative work for those skilled in the art.

FIG. 1 is a schematic flowchart of a power supply method according to the present application;

FIG. 2 is a schematic structural diagram of a power distribution system according to the present application;

FIG. 3 is a schematic structural diagram of a power selector according to the present application;

FIG. 4 is a first schematic structural diagram of a cloud-based power distribution system according to the present application;

FIG. 5 is a second schematic structural diagram of a cloud-based power distribution system according to the present application;

FIG. 6 is a schematic diagram of performing power supply using a single power source according to the present application;

FIG. 7 is a first schematic diagram of power supply in a time slice-based DC multi-source time-division multiplexing mode of the new energy according to the present application;

FIG. 8 is a second schematic diagram of power supply a time slice-based DC multi-source time-division multiplexing mode of the new energy according to the present application;

FIG. 9 is a schematic structural diagram of a power supply apparatus according to the present application; and

FIG. 10 is a schematic structural diagram of an electronic device according to the present application.

### DETAILED DESCRIPTION

To illustrate objectives, solutions and advantages of the present application clearly, the solutions in the embodiments of the present application will be described clearly and completely in conjunction with the accompanying drawings in the present application. The described embodiments are part of the embodiments of the present application, rather than all of the embodiments. All other embodiments obtained by those skilled in the art based on the embodiments of the present application without any creative work belong to the scope of the present application.

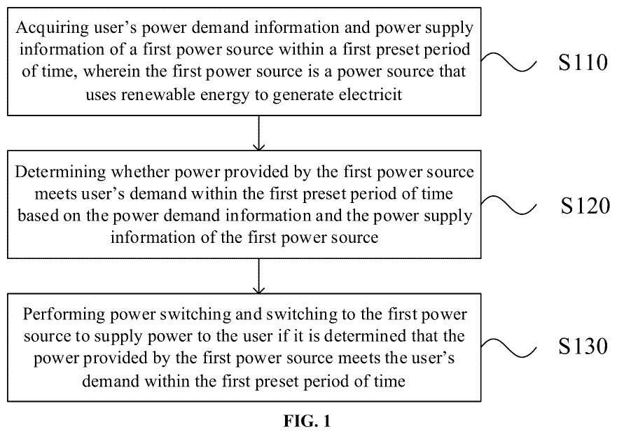

FIG. 1 is a schematic flowchart of a power supply method according to the present application. In the present embodiment, the power supply method is performed by a power selector of the microgrid and includes steps S110 to S130 described below.

S110: acquiring user's power demand information and the power supply information of a first power source within a first preset period of time.

The first power source is a power source that uses renewable energy to generate electricity.

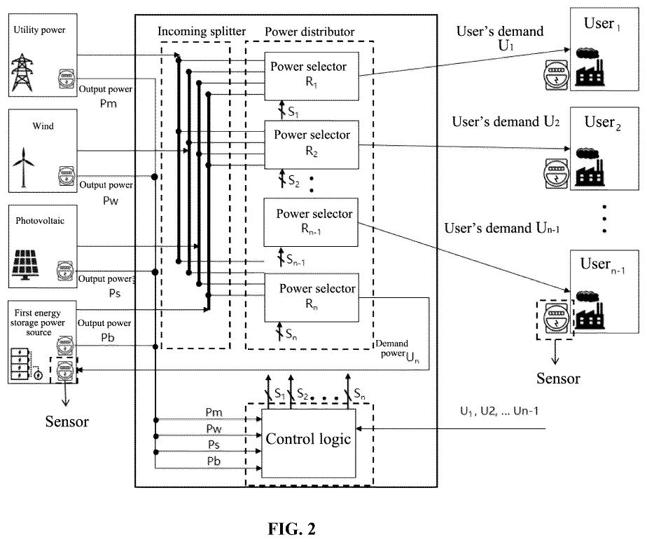

FIG. 2 is a schematic structural diagram of a power distribution system according to the present application.

As shown in FIG. 2, the power distribution system includes a control logic module, a power distributor and an incoming splitter.

The power supply method may be integrated into the control logic module, and controlled and executed by the control logic module.

The power distributor includes multiple power selectors, and is connected to the incoming splitter, a user end and the first energy storage power source respectively. The incoming splitter is connected to multiple power sources for accessing different types of power sources, and the power selector may be connected to different users.

Generally, the power distribution system of the microgrid may simultaneously access multiple power sources, such as wind, photovoltaic, a utility power source and a first energy storage power source in FIG. 2.

The power sources that may be accessed to the power distribution system further includes a biomass energy power source, a geothermal energy power source, a tidal power source, a hydrogen power source, a nuclear power source and other microgrid power sources, etc., and the present embodiment does not limit the types of the power sources.

Specifically, each power source accessed to the power distribution system may be provided with sensors, which are used to detect power supply information of each power source in real time.

Optionally, the sensor includes, but not limited to, a power sensor, a voltage sensor, a current sensor, a multifunctional sensor, etc.

As shown in FIG. 2, a power bus of each power source is connected to the incoming splitter, and the incoming splitter is connected respectively to each power selector in the power distributor, and each power selector may access different types of power sources to supply power to the user end.

The power bus of each power source is connected to the control logic module, so that the control logic module may receive the power supply information of different power sources through sensors.

The control logic module is connected to each user at the user end, and each user end may be provided with a sensor to detect the power demand information of each user in real time.

The control logic module may control the power selector in the power distributor based on the power demand information and the power supply information of different power sources to perform power switching, and switch to different power sources for supplying power to users in different power usage occasions.

It is assumed that there are n power selectors in the power distributor, denoted as R1, R2 . . . Rn−1, Rn respectively in FIG. 2, the control logic module may be connected to n power selector through circuits respectively, and control n power selectors respectively through switches S1, S2 . . . Sn−1, Sn arranged on the circuits.

From the above content, it may be seen that the power distribution system is designed based on the concept of “multi-source time-division multiplexing”: multiple power sources are allowed to be accessed and multiple power sources are simultaneously distributed to different users on demand, and a power distribution scheme that supports multiple inputs and multiple outputs within the same time scale is achieved.

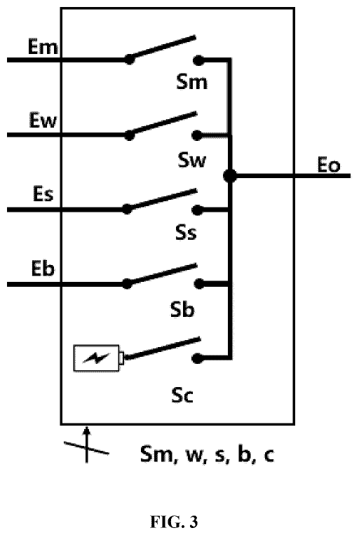

FIG. 3 is a schematic structural diagram of a power selector according to the present application.

Specifically, the power selector is composed of an insulated gate bipolar transistor (IGBT) or a thyristor array and one regional energy storage device.

As shown in FIG. 3, a front end of the power selector may generally be connected to the power bus of each power source respectively, where Em represents a utility power source, Ew represents a wind power source, Es represents a photovoltaic power source, and Eb represents a first energy storage power source, Sm represents a circuit switch of the utility power source, Sw represents the circuit switch of the wind power source, Ss represents the circuit switch of the photovoltaic power source, and Sb represents the circuit switch of the first energy storage power source.

The rear end of the power selector may generally be connected to each user, and Eo represents a power source output to the user end.

It should be noted that the rear end of the power selector may also be connected to the first energy storage power source. For example, the power selector Rn as shown in FIG. 2 may be connected to the first energy storage power source, and the first energy storage power source may perform power storage based on other types of the first power source.

Therefore, in the present embodiment, when the first energy storage power source is used to supply power to the user, the first energy storage power source may be understood as a type of power source. When the first energy storage power source performs power storage based on other types of the first power source, the first energy storage power source may be understood as a type of user.

The regional energy storage device in the power selector is used to provide short-term stable power output when power switching is performed, and Sc represents a circuit switch of the regional energy storage device.

It should be noted that when power switching is performed, a sudden change in output current may cause an arc effect. In order to reduce the risk of power switching operation, minimize damage to switch contacts, and prolong the service life of power devices, each power source is AC power source and the moment when a zero-crossing point of the AC power source occurs may be selected as a switching occasion point for performing power switching to reduce the current passing through the power line during power switching, and decrease power consumption during switching. The regional energy storage device is a small-scale standby energy storage device used for performing compensation power supply during power switching, which ensures stable output power during power switching, reduces the number of charging and discharging cycles of the regional energy storage device, and prolongs the service life of the regional energy storage device.

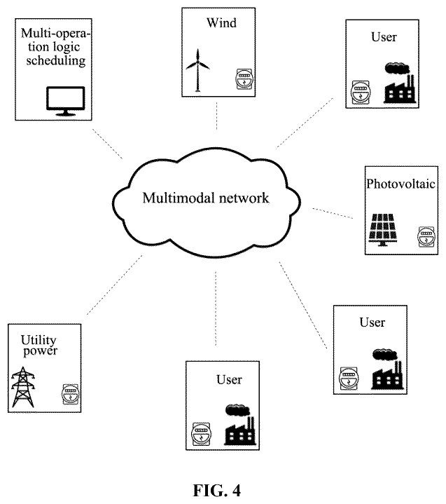

FIG. 4 is a schematic structural diagram of a cloud-based power distribution system according to the present application.

The power distribution system shown in FIG. 2 is displayed in logical functional modules. Various power devices in the power distribution system may be physically interconnected through multimodal networks of different natures, either locally or via the cloud to form a cloud-based power distribution system, as shown in FIG. 4.

Specifically, the power distributor or the multi-operation logic scheduling decider in FIG. 4 may generate dynamic power selection for the power demand of each user based on the user's power demand information and the power supply information within the first preset period of time received through the multimodal network to achieve dynamic power scheduling with small time delay and power demand adaptation.

Furthermore, network and communication security mechanisms, including endogenous security mechanisms, may be implemented on the power distributor or the multi-operation logic scheduling decider to improve the reliability and operational resilience of the overall power grid power scheduling configuration.

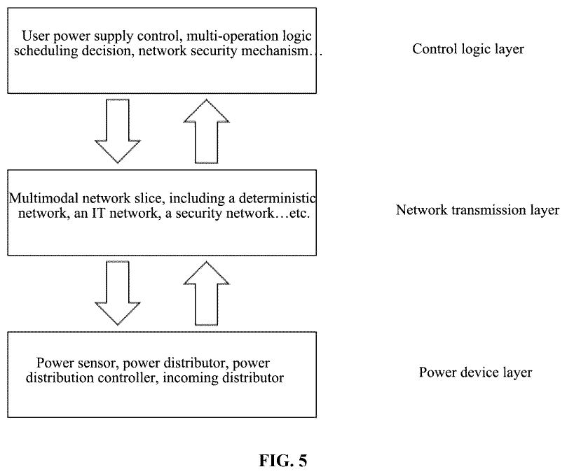

FIG. 5 is another schematic structural diagram of a cloud-based power distribution system according to the present application.

As shown in FIG. 5, the cloud-based power distribution system includes a three-level architecture: a control logic layer, a network transmission layer, and a power device layer.

The control logic layer is used to implement user power supply control, multi-operation logic scheduling decision, network security mechanism, etc. The network transmission layer is used to divide multimodal network slices, provide deterministic networks, IT networks, security networks, etc. The power device layer includes various types of power devices in the microgrid, such as power sensors, power distributors, power distribution controllers, incoming distributors, etc.

Specifically, the control logic module in the power distribution system may acquire power demand information of a user within a first preset period of time and power supply information of a first power source within the first preset period of time.

The first power source is a power source that uses renewable energy to generate electricity.

It should be noted that in the prior art, the power supply method of the microgrid mostly adopts a power switching method based on a large time scale. This power switching method requires the configuration of large volume energy storage batteries and frequent charging and discharging cycles, which not only increases the power loss during the switching process, but also shortens a service cycle of the power devices.

In the present embodiment, the first preset period of time is a small-scale period of time or time slice below the preset threshold, such as 10 milliseconds or 8.33 milliseconds, which is a half-cycle of 50 or 60 Hz AC power, or any reliable DC switching minimum cycle. By adopting a power switching method based on a small-time scale, the power is directly connected to the user in series through a power switch based on a switching time scale to form a single power slice in a non-bus parallel manner according to the switching time interval, and the power is supplied to matched users. Therefore, there is no need to follow the complex output balancing adjustment of multiple power sources under the traditional AC and DC bus forms, the method solves the problems of reverse power flow and power reverse transmission caused by bus balancing deviation, and the problem of low output caused by short-term output fluctuations of new energy due to the power flow and inability to be utilized due to output deviation. In addition, in the present embodiment, because the output is based on smaller time slices, the energy storage demand is reduced without configuring a large volume of energy storage batteries. This implementation addresses the difficulty of precise adaptation of new energy under the bus form. By directly allocating a single power source to a single user based on the switching time scale, the problem of inaccurate measurement of power usage is solved.

Specifically, the user's power demand information within the first preset period of time refers to power demand information of a user estimated within a future small-scale period of time or time slice.

Generally, the power demand information of a user follows a certain rule. Based on historical user's power demand information, such as the user's power demand information during multiple historical small-scale periods of time, the future user's power demand information may be predicted and evaluated to obtain the user's power demand information within the first preset period of time.

S120: determining whether the power provided by the first power source meets the user's demand within the first preset period of time based on the power demand information and the power supply information of the first power source.

Specifically, the control logic module in the power distribution system may determine whether the power provided by the first power source meets the user's demand within the first preset period of time based on the power demand information and the power supply information of the first power source.

The power distribution system of the microgrid may access a power source that uses renewable energy to generate electricity, as well as a traditional utility power source, where the power source that uses renewable energy to generate electricity exhibit large fluctuations in power output but are low in price and environment friendly, and the traditional utility power source offers stable power output but has a volatile price fluctuation. Therefore, if the first power source meets the user's demand at a given time slice or within a first preset period of time, the first power source should be utilized as much as possible.

S130: performing power switching and switching to the first power source to supply power to the user if it is determined that the power provided by the first power source meets the user's demand within the first preset period of time.

The present embodiment provides a power supply method, including: acquiring the user's power demand information and the power supply information of the first power source within the first preset period of time, where the first power source is a power source that uses renewable energy to generate electricity; determining whether the power provided by the first power source meets the user's demand within the first preset period of time based on the power demand information and the power supply information of the first power source; performing power switching and switching to the first power source to supply power to the user if it is determined that the power provided by the first power source meets the user's demand within the first preset period of time. In this manner, the first power source is a power source that uses renewable energy to generate electricity. Based on the power demand information and the load information of the first power source within the first preset period of time, it is determined whether the power provided by the first power source meets the user's demand within the first preset period of time. If it is determined that the power provided by the first power source meets the user's demand within the first preset period of time, the power switching is performed, and a current power source is switched to the first power source to supply power to the user. Therefore, under the condition of multiple power sources, the power source that uses renewable energy to generate electricity may be prioritized for the power supply of microgrid users, thereby reducing the pollution to the environment on the premise of ensuring the power supply of users. The power supply method is scientific and reasonable.

In some embodiments, the power demand information includes user demand power. The power supply information of the first power source includes output power of the first power source. The first power source includes at least one of a wind power source, a photovoltaic power source, a hydraulic power source, a biomass energy power source, a geothermal energy power source, or a first energy storage power source.

Optionally, the power demand information may further include user demand voltage, user demand current, etc., and the power supply information of the first power source may further include output voltage and output current of the first power source, etc.

Optionally, the first power source may further include a tidal energy power source, a hydrogen energy power source, a nuclear energy power source, etc.

It may be understood that the first power source may further include power sources provided by other microgrids that use renewable energy to generate electricity.

It may be understood that some microgrids may access only one power source or multiple power sources. The present embodiment does not limit the types and quantities of power sources accessed by the microgrid.

Determining whether the power provided by the first power source meets the user's demand within the first preset period of time based on the power demand information and the power supply information of the first power source includes: comparing output power of each first power source with the user demand power to determine whether there is a first power source of which output power is greater than or equal to the user demand power; and determining that the power provided by the first power source meets the user's demand within the first preset period of time if there is the first power source of which output power is greater than or equal to the user demand power. Performing the power switching and switching to the first power source to supply power to the user if it is determined that the power provided by the first power source meets the user's demand within the first preset period of time includes: switching to the first power source of which the output power is greater than or equal to the user demand power for independently supplying power to the user.

For each power selector, only one power source may be used to independently supply power to the user during each first preset period of time.

Specifically, the power distribution system may detect and acquire in real time the output power of different power sources (including the first power source and the utility power source), changes in power output of different power sources, and the demand power of each user. Taking into account factors such as the inverter conversion delay, the fluctuation of new energy output, and the estimated output power of the power source after the power switching cycle, it may be determined whether the power source meets the power demands of the user and make a decision on what kind of power source to be provided to the user based on this.

Taking FIG. 2 as an example, the power distribution system in FIG. 2 may detect and acquire in real time output power P_{w}(t) of a wind power source

$$\frac{d ( t )}{dt} ,$$

power output change

$$\frac{{dP}_{s} ( t )}{dt}$$

of the photovoltaic power source, and the user demand power Uᵢ(t) of each user.

Specifically, the traditional utility power source has the characteristics of stable output and large price fluctuations. Under the premise of environmental friendliness, energy saving and carbon reduction, the power distribution scheme of the microgrid needs to include a wind power source, a photovoltaic power source and other energy storage devices to meet the power demands of users.

Assuming that the user demand power of the i-th user during the future preset small-scale period of time ΔT is denoted as Uᵢ(t+ΔT), and output power of different power sources is denoted as Pⱼ(t+ΔT), when the following equation is satisfied, the power distribution system may use one power source to independently supply power to the user:

$${U}_{i} ( t + Δ T ) \leq {P}_{j} ( t + Δ T ) ;$$

$$j ∈ \{ w , s , b , m… \} ;$$

where t represents the current time; j represents the j-th power source, where w represents wind power, s represents photovoltaic power, b represents energy storage device, and m represents utility power.

It should be noted that if there are multiple types of power sources that may independently supply power, the first power source should be used as much as possible.

Preferably, if there are multiple types of power sources that may provide independent power supply, the first power source with the largest power output power may be selected to independently supply power to the user.

Specifically, the power selector compares the output power of each first power source with the user demand power and determines whether there is a first power source of which output power is greater than or equal to the user demand power.

If there is a first power source of which output power is greater than or equal to the user demand power, it is determined that the power provided by the first power source meets the user's demand within the first preset period of time.

If it is determined that the power provided by the first power source meets the user's demand within the first preset period of time, and a current power source is switched to the first power source of which output power is greater than or equal to the user demand power to independently supply power to the user.

Continuing to refer to FIG. 2, Pm represents the output power of the utility power source, Pw represents the output power of the wind power source, Ps represents the output power of the photovoltaic power source, Pb represents the output power of the first energy storage power source, U1, U2, . . . Un−1 represent the user demand power of user 1, user 2, . . . user n−1, respectively, and Un represents the demand power of the first energy storage power source when energy storage is performed based on other types of first power sources.

Taking user 1 as an example, the output power of the utility power source Pm, the output power of the wind power source Pw, the output power of the photovoltaic power source Ps, and the output power of the energy storage device power source Pb are respectively compared with the user demand power U1 to determine whether there is a first power source of which the output power is greater than or equal to the user demand power U1.

If there is a first power source of which the output power is greater than or equal to the user demand power U1, it is determined that the power provided by the first power source meets the user's demand. If it is determined that the power provided by the first power source meets the user's demand, a current power source is switched to the first power source of which the output power is greater than or equal to the user demand power to independently supply power to the user.

For example, if the output power of the wind power source Pw is greater than or equal to the user demand power U1, it is determined that the power provided by the wind power source meets the user's demand, and the current power source may be switched to the wind power source, and the wind power may independently supply power to the user.

It should be noted that the power switching is completed based on the power distributor sending a power selection control signal Sᵢ to the power selector Rᵢ corresponding to the user.

A front end of the power selector Rᵢ is connected to the power bus of various power sources including a utility power source and a new energy power source (i.e., a first power source), and the rear end of the power selector Rᵢ may be connected to each user and the first energy storage power source in the first power source, respectively.

It may be understood that, for the entire microgrid or power distribution system, when there are multiple users, each power selector may be connected to one user, and the user demand power of different users within the same first preset period of time may be different. At this time, each power selector needs to independently compare the user demand power of the corresponding user with the output power of the first power source to make a power selection for the user.

For example, if the output power of the wind power source Pw is greater than or equal to the user demand power U1 of user 1, and the output power of the photovoltaic power source Ps is less than the user demand power U1 of user 1, the current power source of user 1 is switched to the wind power source, and the wind power source is used to independently supply power to user 1. At the same time, if the output power of the photovoltaic power source Ps is greater than or equal to the user demand power U2 of user 2, the current power source of user 2 is switched to the photovoltaic power source, and the photovoltaic power source is used to independently supply power to user 2.

It may be seen from this that, within the same first preset period of time, although each user may only select one first power source, the first power sources selected by different users may be different, and the new energy power source of the entire microgrid or power distribution system may be fully utilized to completely utilize the new energy.

In some embodiments, after determining whether the power provided by the first power source meets the user's demand based on the power demand information and the power supply information of the first power source, the method further includes: performing power switching, and switching to a second power source to supply power to the user if it is determined that the power provided by any first power source fails to meet the user's demand within the first preset period of time, where the second power source is a utility power source; and performing energy storage on the first energy storage power source based on the first power source.

It may be understood that, when the power selector cannot guarantee the user's demand, it may be considered to use the utility power source for supplying power to ensure that the user's demand may be met, and store the power of other types of first power sources in the first energy storage power source, and evaluate whether the first energy storage power source meets the user's demand as the energy storage power source in the next time slice cycle.

In some embodiments, after determining whether the power provided by the first power source meets the user's demand based on the power demand information and the power supply information of the first power source, the method further includes: determining a difference between the user demand power and the output power of each first power source, respectively if it is determined that the power provided by any first power source fails to meet the user's demand within the first preset period of time; determining whether there is a first power source corresponding to a difference less than or equal to a preset threshold; switching to the first power source with the difference less than or equal to the preset threshold for independently supplying power to the user within the first preset period of time if there is a first power source corresponding to the difference less than or equal to the preset threshold; during the second preset period of time, performing power switching, and switching to the first power source of which output power is greater than the user demand power to supply power to the user, and complementing a power demand difference of the user within the first preset period of time; where the second preset period of time is a future period of time of the first preset period of time.

In some cases, although the power provided by the first power source cannot fully meet the user's demand within the first preset period of time, the difference between the power that the first power source may provide and the user's demand is not significant, and the user will not be unable to use electricity normally due to a small amount of power shortage within the first preset period of time. At this time, it may be considered to continue to supply power to the user based on the first power source within the first preset period of time, and complement the power demand difference of the user within the first preset period of time within a future period of time.

Specifically, if it is determined that the power provided by any first power source fails to meet the user's demand within the first preset period of time, the difference between the user demand power and the output power of each first power source is determined respectively; and it is determined whether there is a first power source corresponding to the difference less than or equal to the preset threshold.

If there is a first power source corresponding to the difference less than or equal to the preset threshold, a current power source is switched to the first power source corresponding to the difference less than or equal to the preset threshold to independently supply power to the user within the first preset period of time, and within the second preset period of time, the power switching is performed to switch to the first power source of which output power is greater than the user demand power to supply power to the user to complement a power demand difference of the user within the first preset period of time.

The second preset period of time is a future period of time of the first preset period of time.

Generally, if the power provided by different first power sources meets the average user's demand within the first preset period of time and the second preset period of time, this method may be selected for supplying power.

In some embodiments, after determining whether there is a first power source corresponding to the difference less than or equal to the preset threshold, the method further includes: if there is no first power source corresponding to the difference less than or equal to the preset threshold, performing power switching, and switching to the second power source to supply power to the user; where the second power source is a utility power source.

In some embodiments, the method further includes: performing power supply compensation based on a second energy storage power source when power switching is performed.

When power switching is performed, a similar arc effect may occur.

In order to reduce the risk of power switching operation, minimize damage to switch contacts, and prolong the service life of power devices, each power source is AC power source, and the moment when a zero-crossing point of the AC power source occurs may be selected as a switching occasion point for performing power switching to reduce the current passing through the power line during power switching, and decrease power consumption during switching.

Continuing to refer to FIG. 3, when power switching is performed, the regional energy storage device in the power selector may provide a short-term stable power output for performing compensation power supply at the user end.

Preferably, AC power is used as the power source. When power switching is performed, in order to avoid arcing caused by changes in current or voltage at the power contact, which causes power hazards or reduces the service life of the device, the power source switching should be controlled at the zero voltage of each phase of power.

The power supply method provided in the present embodiment combines the traditional utility power source with stable output and price fluctuations, and the first power source with fluctuating output and controllable price, to track the user's power demand information at a small time scale to output the predicted delayed user power. Based on the power consumption strategy of the user or microgrid, a dynamic clever power distribution power supply method is established to form an economical and stable microgrid.

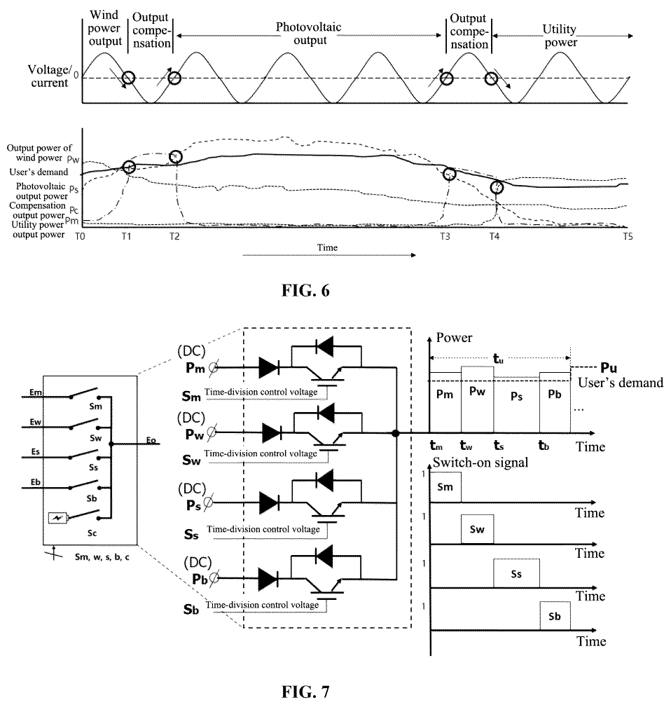

The present application further provides a specific example of a power supply method. FIG. 6 is a schematic diagram of a power supply using a single power source according to the present application.

FIG. 6 shows the relationship between voltage-time and power-time on the single-phase output power line.

As shown in FIG. 6, within the period of time T0˜T1, the output power of the wind power source (i. e. wind power) is greater than the power demand power of the user within the period of time T0˜T1. The power selector selects the wind power source to independently supply power to the user.

Furthermore, the output power of the wind power source decreases, while the output power of the photovoltaic power source gradually increases. The power selector may switch to the photovoltaic power source to independently supply power to the user based on the increase in the output power of the photovoltaic power source.

In the process of switching the wind power source to the photovoltaic power source, that is, within the period of time T1˜T2, the regional energy storage device in the power selector performs compensation power supply to compensate r the power shortage during the gradual increase of the output power of the external photovoltaic power, as well as to compensate for the unstable output power of the user-end caused by the power switching, and the power selector switches to the photovoltaic power at moment T2, and the photovoltaic power source is used to independently supply power to the user.

Specifically, the power selector continuously detects the power supply information of the wind power source and the photovoltaic power source and the user's power demand information, determines that the output power of the photovoltaic power source is greater than the power demand power of the user within the period of time T2˜T3, and outputs the power selector control signal Sᵢ to control the power selector to provide photovoltaic power to the user.

Afterwards, the output power of the photovoltaic power source also gradually decreases. At the moment T3, both the photovoltaic power source and the wind power source fails to meet the user's demand. At this time, the power selector will decide to use the utility power source.

In the power half-cycle before switching the external power source to the utility power source, that is, the period of time T3˜T4, the regional energy storage device in the power selector may quickly and stably performing compensation power supply in a short period of time until the moment T4, when the utility power source may stably provide sufficient power to the user. The power selector continuously controls the selection of the utility power source to provide power through the control signal Sᵢ.

It may be understood that the black circle in FIG. 6 represents the moment of power source switching, that is, the zero voltage point of each phase of power. The arrows in the voltage-time graph of FIG. 6 also illustrate the moment when the power source switching occurs, reducing the possibility of arcing at the contact during switching and reducing the power consumption during the switching.

The present application further provides another specific example of the power supply method. FIG. 7 is a first schematic diagram of power supply in a time slice-based DC multi-source time-division multiplexing mode of the new energy according to the present application.

When used in AC applications, the power switch may be adjusted according to the characteristics shown in FIG. 6. This example switches the user demand power to a single user side based on a time slice that each of the first power sources meets, and there is no superposition relationship in any time slice to meet the user's demand within a given time range. This method is coupled in a time slice manner without the need to balance multiple first power sources and second power sources through phase modulation, voltage modulation, output and the like according to the traditional AC/DC bus configuration to form a suitable output ratio configuration.

As shown in FIG. 7, Pm represents the output power of the utility power source, Pw represents the output power of the wind power source, Ps represents the output power of the photovoltaic power source, Pb represents the output power of the first energy storage power source, and Pu represents the user's demand within a given time interval (i.e., the user demand power).

At moment tm, Pm meets the user's demand, i.e., Pm≥Pu, then the Sm signal is set to switch Pm to Pu, and other power sources Pb, Pw, and Ps are in switch-off state.

At moment tw, it is detected that Pm cannot provide sufficient output power, then the first power source that meets the power demand of Pu in Pw and Ps is switched on, which is Pw in FIG. 7.

At moment ts, it is found that the first power sources such as Pb and Pw fails to meet the Pu demand, i.e., Pb<Pu and Pw<Pu, then at moment ts, Ss switch-on signal was sent to switch to Ps for supplying power to Pu, and Sb, Sw, and Sm are all in the switch-off signal state.

At moment tb, it is detected that the first power sources such as Ps and Pw fails to meet the Pu demand, i.e., Ps<Pu and Pw<Pu, then at moment tb, the Sb closing signal was sent to switch to Pb for supplying power to Pu, and Ss, Sw, and Sm are all in the switch-off signal state.

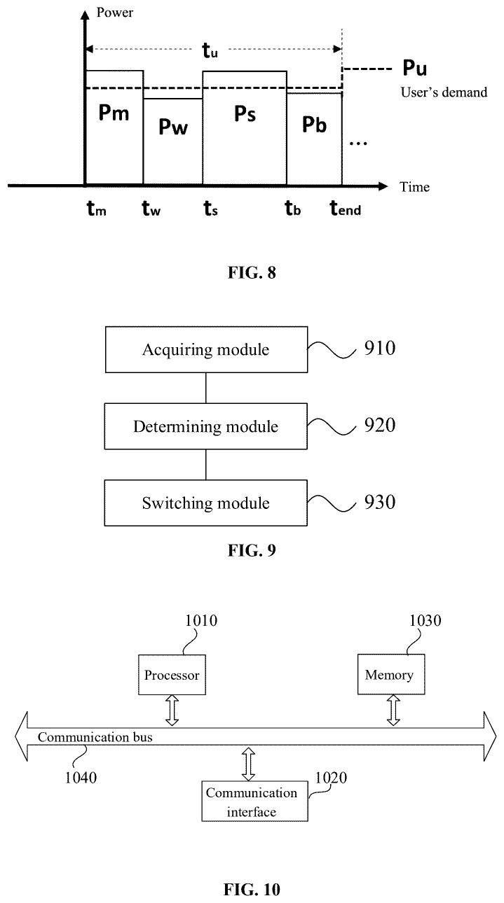

The present application further provides yet another specific example of the power supply method. FIG. 8 is a second schematic diagram of power supply in a time slice-based DC multi-source time-division multiplexing mode of the new energy according to the present application.

As shown in FIG. 8, it is assumed that the user's demand Pu is an average power demand within a given time tu, for examiner, the power demand of the thermal boiler is the average output within a certain time, the power adaptation method in FIG. 7 is modified to adjust a switching time based on the average output of the first power source Pw, Ps, Pb and the second power source Pm within the user demand duration tu, and meet the following conditions:

$$Pm \cdot ( tw - tm ) + Pw \cdot ( ts - tw ) + Ps \cdot ( tb - ts ) + Pb \cdot ( tend - tb ) \geq Pu \cdot ( tend - tm ) .$$

At moment tm, Pm meets the user's demand, i.e., Pm≥Pu, then the Sm signal is set to switch Pm to Pu, and other power sources Pb, Pw, and Ps are in a switch-off state.

At moment tw, it is detected that the first power sources such as Pw and Ps fails to meet the power demand of Pu, but the difference between Pw and Pu is less than or equal to the preset threshold, and other power sources may be used in the future period of time to complement the power difference of Pu within the period of time tw-ts, then the Sw signal is set to switch Pw to Pu, and other power sources Pb, Pm, and Ps are in a switch-off state.

At moment ts, it is found that the first power sources such as Pb and Pw fails to meet the Pu demand, i.e., Pb<Pu and Pw<Pu, then at moment ts, the Ss switch-off signal was sent to switch to Ps for supplying power to Pu, and Sb, Sw, and Sm are all in the switch-off signal state.

At moment tb, it is found that the first power sources such as Ps, Pw, and Pb fails to meet the Pu demand, i.e., Ps<Pu, Pw<Pu, and Pb<Pu, but the difference between Pb and Pu is less than or equal to the preset threshold, and other power sources may be used in the future period of time to complement the power difference of Pu in the tw-ts period of time during the future period of time. Then, at moment tb, the Sb switch-on signal was sent to switch to Pb for supplying power to Pu, and Ss, Sw, and Sm are all in the switch-off signal state.

The present application further provides a power supply apparatus. FIG. 9, is a schematic structural diagram of a power supply apparatus according to the present application. In the present embodiment, the power supply apparatus includes an acquiring module 910, a determining module 920, and a switching module 930.

The acquiring module 910 is used for acquiring user's power demand information and power supply information of a first power source within the first preset period of time.

The first power source is a power source that uses renewable energy to generate electricity.

The determining module 920 is used for determining whether the power provided by the first power source meets the user's demand within the first preset period of time based on the power demand information and the power supply information of the first power source.

The switching module 930 is used for performing power switching and switching to the first power source to supply power to the user if it is determined that the power provided by the first power source meets the user's demand within the first preset period of time.

In some embodiments, the power demand information includes user demand power, and the power supply information of the first power source includes the power output power of the first power source, and the first power source includes at least one of a wind power source, a photovoltaic power source, a hydraulic power source, a biomass energy power source, a geothermal energy power source, or a first energy storage power source.

The determining module 920 is used for comparing the power output power of each first power source with the user demand power, and determining whether there is a first power source of which output power is greater than or equal to the user demand power; and determine that the power provided by the first power source meets the user's demand within the first preset period of time if there is the first power source of the output power being greater than or equal to the user demand power.

The switching module 930 is used for switching to the first power source of which the output power is greater than or equal to the user demand power for independently supplying power to the user.

In some embodiments, the switching module 930 is used for performing power switching and switching to the second power source to supply power to the user if it is determined that the power provided by any first power source fails to meet the user's demand within the first preset period of time, where the second power source is a utility power source; and performing energy storage on the first energy storage power source based on the first power source.

In some embodiments, the switching module 930 is used for determining a difference between the user demand power and the power output power of each first power source if it is determined that the power provided by any first power source fails to meet the user's demand within the first preset period of time; determining whether there is a first power source corresponding to the difference less than or equal to a preset threshold; switching to the first power source with the difference less than or equal to the preset threshold for independently supplying power to the user within the first preset period of time if there is a first power source corresponding to the difference less than or equal to the preset threshold; during the second preset period of time, performing power switching, switching to the first power source of which the output power is greater than the user demand power to supply power to the user, and complementing the power demand difference of the user within the first preset period of time; where the second preset period of time is a future period of time of the first preset period of time.

In some embodiments, the switching module 930 is used for performing power switching and switching to the second power source to supply power to the user if there is no first power source corresponding to the difference less than or equal to the preset threshold; where the second power source is a utility power source.

In some embodiments, the power supply apparatus further includes a compensating module.

The compensating module is used to performing compensation power supply based on the second energy storage power when performing power switching.

The present application further provides an electronic device. FIG. 10 is a schematic structural diagram of an electronic device according to the present application. As shown in FIG. 10, the electronic device may include: a processor 1010, a communication interface 1020, a memory 1030 and a communication bus 1040, where the processor 1010, the communication interface 1020, and the memory 1030 communicate with each other through the communication bus 1040. The processor 1010 may call the logic instructions in the memory 1030 to execute the power supply method.

In addition, the logic instructions in the above-mentioned memory 1030 may be implemented in the form of software functional units and may be stored in a computer-readable storage medium when sold or used as an independent product. The solution of the present application, in essence, or the part that contributes to the prior art, or the part of the solution, may be embodied in the form of a software product, which is stored in a storage medium and includes a number of instructions for enabling a computer device (which may be a personal computer, a server, or a network device, etc.) to perform all or part of the steps of the methods described in various embodiments of the present application. The aforementioned storage medium includes various mediums such as USB flash drives, mobile hard disk, read-only memory (ROM), random access memory (RAM), magnetic disk or optical disk, etc., which may store program code.

The present application further provides a non-transitory computer-readable storage medium storing a computer program, where the computer program, when executed by a processor, implements any one of the power supply methods described above.

The present application further provides a computer program product, including a computer program, which may be stored on a non-transitory computer-readable storage medium, where the computer program, when executed by a processor, implements any one of the power supply methods described above.

The device embodiments described above are merely illustrative, where the units described as separate components may or may not be physically separated, and the components displayed as units may or may not be physical units, that is, they may be located in one place or distributed on multiple network units. Some or all of the modules may be selected according to actual needs to achieve the purpose of the scheme of the present embodiment. Those skilled in the art may understand and implement it without paying creative labors.

Through the description of the above implementation, those skilled in the art may clearly understand that each implementation may be implemented by means of software and necessary general hardware platform, and of course, through hardware. Based on this understanding, the above solution may essentially or the part that contributes to the prior art may be embodied in the form of a software product, which may be stored in a computer-readable storage medium, such as ROM/RAM, a magnetic disk, an optical disk, etc., including a number of instructions for a computer device (which may be a personal computer, a server, or a network device, etc.) to execute the methods described in each embodiment or some parts of the embodiment.

Finally, it should be noted that the above embodiments are only used to illustrate the solutions of the present application, and not to limit it. Although the present application has been described in detail with reference to the aforementioned embodiments, those skilled in the art should understand that they may still modify the solutions described in the aforementioned embodiments or make equivalent replacements for some of the features therein. And these modifications or replacements do not deviate the essence of the corresponding solutions from the scope of the solutions of the embodiments of the present application.

1. A power supply method, comprising:
acquiring user's power demand information and power supply information of a first power source within a first preset period of time, wherein the first power source is a power source that uses renewable energy to generate electricity;
determining whether power provided by the first power source meets user's demand within the first preset period of time based on the power demand information and the power supply information of the first power source; and
performing power switching and switching to the first power source to supply power to the user if it is determined that the power provided by the first power source meets the user's demand within the first preset period of time.

2. The power supply method of claim 1, wherein the power demand information comprises user demand power,
the power supply information of the first power source comprises output power of the first power source, and
the first power source comprises at least one of a wind power source, a photovoltaic power source, a hydraulic power source, a biomass energy power source, a geothermal energy power source, or a first energy storage power source;
determining whether the power provided by the first power source meets the user's demand within the first preset period of time based on the power demand information and the power supply information of the first power source, comprises:
comparing output power of each first power source with the user demand power to determine whether there is a first power source of which output power is greater than or equal to the user demand power; and
determining that the power provided by the first power source meets the user's demand within the first preset period of time if there is the first power source of which output power is greater than or equal to the user demand power;
performing the power switching and switching the first power source to supply power to the user if it is determined that the power provided by the first power source meets the user's demand within the first preset period of time comprises:
switching to the first power source of which the output power is greater than or equal to the user demand power for independently supplying power to the user.

3. The power supply method of claim 2, wherein after determining whether the power provided by the first power source meets the user's demand based on the power demand information and the power supply information of the first power source, the method further comprises:
performing power switching, and switching to a second power source to supply power to the user if it is determined that power provided by any first power source fails to meet the user's demand within the first preset period of time, wherein the second power source is a utility power source; and
performing energy storage on the first energy storage power source based on the first power source.

4. The power supply method of claim 2, wherein after determining whether the power provided by the first power source meets the user's demand within the first preset period of time based on the power demand information and the power supply information of the first power source, the method further comprises:
determining a difference between the user demand power and the power output power of each first power source respectively if it is determined that the power provided by any first power source fails to meet the user's demand within the first preset period of time;
determining whether there is a first power source corresponding to the difference less than or equal to a preset threshold;
switching to the first power source corresponding to the difference less than or equal to the preset threshold for independently supplying power to the user within the first preset period of time if there is the first power source corresponding to the difference less than or equal to the preset threshold; and
within a second preset period of time, performing power switching and switching to a first power source of which output power is greater than the user demand power to supply power to the user, and complementing a power demand difference of the user within the first preset period of time,
wherein the second preset period of time is a future period of time of the first preset period of time.

5. The power supply method of claim 4, wherein after determining whether there is the first power source corresponding to the difference less than or equal to a preset threshold, the method further comprises:
performing power switching and switching to a second power source to supply power to the user if there is no first power source corresponding to the difference less than or equal to the preset threshold,
wherein the second power source is a utility power source.

6. The power supply method of claim 1, further comprising:
performing compensation power supply based on a second energy storage power when power switching is performed.

7. A power supply apparatus, comprising:
an acquiring module, used for acquiring user's power demand information and power supply information of a first power source within a first preset period of time, wherein the first power source is a power source that uses renewable energy to generate electricity;
a determining module, used for determining whether power provided by the first power source meets user's demand within the first preset period of time based on the power demand information and the power supply information of the first power source; and
a switching module, used for performing power switching and switching to the first power source to supply power to the user if it is determined that the power provided by the first power source meets the user's demand within the first preset period of time.

8. An electronic device, comprising a memory, a processor and a computer program stored in the memory and executable on the processor, wherein the processor implements the power supply method of claim 1 when executing the program.

9. A non-transitory computer-readable storage medium storing a computer program, wherein the computer program, when executed by a processor, implements the power supply method of claim 1.

10. A computer program product, comprising a computer program, wherein the computer program, when executed by a processor, implements the power supply method of claim 1.
